(19) United States
(12) Patent Application Publication
(10) Pub. No.: US 2009/0106735 A1
(43) Pub. Date: Apr. 23, 2009

(54) AMBIENT EXPERIENCE INSTRUCTION GENERATION

(75) Inventors: David A. Eves, Pound Hill (GB); Richard Stephen Cole, Redhill (GB); Jan Baptist Adrianus Maria Horsten, Eindhoven (NL)

Correspondence Address: RISSMAN JOBSE HENDRICKS & OLIVERIO, LLP, 100 Cambridge Street, Suite 2101, BOSTON, MA, 02114, US

(73) Assignee: KONINKLIJKE PHILIPS ELECTRONICS N.V., EINDHOVEN (NL)

(21) Appl. No.: 12/300,472

(22) PCT Filed: May 8, 2007
(86) PCT No.: PCT/IB07/51712

§ 371 Date: Nov. 12, 2008

(30) Foreign Application Priority Data
May 19, 2006 (EP) 06114234.5

(51) Int. Cl. G06F 9/44

(52) U.S. Cl. 717/114

(57) ABSTRACT

A method for generating a sequence of instructions comprises determining one or more time values, accessing a pool of markup language fragments, and processing the markup language fragments according to the or each time value. The output of the processed fragments is then combined into a sequence of time-stamped instructions either as a single file or as a number of device-specific files. A system implementing the method is also described.

This invention relates to a method and system for generating a sequence of instructions.

The provision of entertainment via electronic devices to end users takes many different forms. For example, music can be provided by dedicated audio equipment, and video or visual experiences can be delivered by televisions and via devices such as video disc or “DVD” players. The personal computer (PC) is also used to deliver entertainment products such as films and games. The augmentation of a specific entertainment experience is a technical field where the aim is to increase the user enjoyment of the entertainment by providing extra experiences over and above the user's normal experience of whatever it is that they are enjoying. A very simple example of such augmentation exists in a known piece of computer software that provides on-screen graphics while a user is listening to music. The normal experience is the music, with the augmentation being provided by the visual display on the PC.

More complicated augmentation systems are known. For example, United States Patent Application Publication US 2002/0169817 describes a real-world representation system and language. The real-world representation system comprises a set of devices, each device being arranged to provide one or more real-world parameters, for example audio and visual characteristics. At least one of the devices is arranged to receive a real-world description in the form of an instruction set of a markup language and the devices are operated according to the description. General terms expressed in the language are interpreted by either a local server or a distributed browser to operate the devices to render the real-world experience to the user. The system described in this document uses a markup language to describe components of an experience, which are then interpreted in the devices surrounding the user to provide aspects of the user's ambient environment.

Further enhancement of such a system is described in United States Patent Application Publication US 2005/0204280, which relates to a dynamic markup language. In this document a method for generating a markup language document is described, which comprises accessing a pool of active markup language fragments, processing the fragments using at least one predetermined factor such as time, and generating a markup language document accordingly. In this way, a declarative markup language document is derived, but with content that is effectively dynamic. This system is used to process a series of complicated markup language fragments into a single document, which can then be used in the system of US 2002/0169817 above, to control the devices of that system.

Systems such as those described above, which provide markup language fragments and/or documents for use by devices producing augmentation of an experience, can be computationally demanding for devices of limited functionality. Such systems can also be restrictive in that legacy devices may not be able to function properly in the system, if they are unable to provide the necessary processing functionality to participate in the augmentation.

It is therefore an object of the invention to improve upon the known art.

According to a first aspect of the present invention, there is provided a method for generating a sequence of instructions comprising determining one or more time values, accessing a pool of markup language fragments, processing the markup language fragments according to the or each time value, and producing a sequence of time-stamped instructions from the processed markup language fragments.

According to a second aspect of the present invention, there is provided a computer program product on a computer readable medium comprising a set of commands for generating a sequence of instructions, the set comprising commands for determining one or more time values, accessing a pool of markup language fragments, processing the markup language fragments according to the or each time value, and producing a sequence of time-stamped instructions from the processed markup language fragments.

According to a third aspect of the present invention, there is provided a system for generating a sequence of instructions comprising a processor arranged to determine one or more time values, to access a pool of markup language fragments, to process the markup language fragments according to the or each time value, and to produce a sequence of time-stamped instructions from the processed markup language fragments.

Owing to the invention, it is possible to provide a method of generating a sequence of time-stamped instructions from the original markup language fragments. This allows a more efficient operation of an augmentation system, if such a system becomes closed, i.e. context cannot change and no content be added or removed during such a period. It is therefore advantageous to take the ‘dynamic’ collection of fragments and convert this into a sequential set of instructions. The method and system allow a flattening of a set of dynamic markup language fragments (for a closed system) to remove all conditional elements and to determine the specific actions within an augmentation system and when these actions must be carried out.

This translation process will then allow a smaller and/or more efficient playback engine to maintain the continued playback of the described content. This might typically occur if a single initial body of content is delivered and then the source disconnected, for example, markup language experience description delivered from the Internet at the start of a movie playback. In effect the system runs ahead of time to produce all the predicted instructions or content descriptions against the trigger times. This can then be stored in the form of a time-annotated list of instructions.

In this circumstance, the engine controlling the operation of the augmentation system just has to process the sequence of instructions synchronising the triggering of specific instructions against the engine's internal clock. This requires a much less processor intensive and simpler algorithm. An extension of the idea would allow a sub part of the system, a single rendering device such as a light for example, to have a pre-processed sequence of events just for itself.

The invention provides the advantage that in many situations it is possible to reduce ongoing processor load by this technique, either so that a system has only a single instance of high activity, for example, a ‘boot up’ period. This then frees processor resources to another application, for example, a game or movie playback. Similarly, processing resources freed up can be used to do load balancing, pre-determining sections of playback during periods of high processor availability.

The invention can also deliver advantages in other circumstances, such as when the limitation of any system may be size of memory or total processor capability. Hence, the ability to carry out a pre-processing step (probably occurring offline) will allow limited or basic equipment to achieve similar results as a full or sophisticated version of the equipment would, with the restriction that limited or basic equipment operates as a closed system.

In such a case the flattening achieved by the pre-processing could even be carried out by a service accessed across a network—that is, by describing the end-system to the server based engine providing the service, the markup language content can be converted to a flattened form before transmission. This will provide gains both in reduced bandwidth, and in allowing the client device to be relatively ‘dumb’ whilst still maintaining the advantages of a more complex augmentation system.

In this latter case it could be imagined that very simple playback software could be included into, for example, a special movie ‘light’ that receives the simplified ‘closed’ description from a parent device or service but then is able to continue playback without further contact with the parent. This can reduce bandwidth requirements, add to system robustness and reduce processor load on the parent. If the parent device requires the closed system to change then an interruption could be initiated and the process repeated.

Advantageously, the step of determining the or each time value comprises accessing the pool of markup language fragments and determining the or each time value within one or more markup language fragments. A time value is required to determine when events such as lights turning on and off should take place. By determining the time values to be used from the actual markup fragments themselves, all of the time values utilised by the set of markup language fragments will be captured, and this process of determining the time values can be executed quickly and efficiently.

In one embodiment, the production of the sequence of time-stamped instructions comprises generating a single file comprising the sequence of time-stamped instructions. This is the most efficient generation of the instructions, simply placing them in order in a single file, which can be of any suitable format supported by the engine that is controlling the augmentation of the entertainment experience.

In a second embodiment, the production of the sequence of time-stamped instructions comprises generating a plurality of device-specific files, each comprising respective sequences of time-stamped instructions. This method of generating the instructions, which is marginally more complicated than the first embodiment, supports an augmentation system that will simply pass each device-specific file on to the respective device that needs the instructions. This simplifies the actual running of the augmentation system, as there is no need to continually pass instructions from the engine to individual devices, as those devices are provided with all of their required instructions ahead of time.

Preferably the method of generating the sequence of instructions further comprises accessing an end-system description and during the step of producing the sequence of time-stamped instructions using the end-system description to determine the time-stamped instructions. This end-system description describes the capabilities of the actual augmentation system that will use the generated instructions. By accessing this information as the instructions are being created, later processing efficiency can be achieved. For example, if a markup language fragment refers to changes in temperature, but there is no temperature-controlling device in the end system (as shown in the end-system description), then these fragments will not be processed and there will be no instructions relating to temperature change.

In one embodiment, the accessing of the end-system description is carried out across a network, and the method further comprises transmitting the sequence of time-stamped instructions back across the network to the location of the end-system description. This has the advantage that the processing of the markup language fragments into a sequence of instructions can take place remotely from the actual augmentation system. For example, the processor that is carrying out the generation of the instructions can be part of a central service that can be accessed over a network, with the service receiving the end-system description and accordingly generating the sequence of time-stamped instructions for transmission back to the location of the augmentation system. This removes the need for the processing system that is actually producing the sequence of instructions to be present at the location of the augmentation system.

Ideally, the method of generating the instructions further comprises monitoring the pool of markup fragments, and following detection of a change in the pool of markup fragments, re-producing the sequence of time-stamped instructions. If new fragments are added to the pool of markup language fragments, then this implies a change in the functioning of the augmentation system relative to the experience being delivered to the user. New fragments could refer to new devices or new parameter changes of the current devices. In this circumstance the sequence of time-stamped instructions needs to be generated again, and it is therefore advantageous to monitor the pool of fragments and to rerun the generation cycle if any change to the pool of fragments occurs.

Advantageously, the method further comprises, during the production of the sequence of time-stamped instructions, transmitting any generated instructions to one or more devices. The generation of time-stamped instructions need not occur as a closed function. For example, as the instructions are generated, they can then be passed forward to the engine running the augmentation system, or to the individual devices carrying out the augmentation. This is particularly advantageous when there is a very large pool of fragments and/or set of devices, and the actual sequence of instructions will be relatively long. The instructions are created and forwarded immediately, even as new instructions are being formulated.

Embodiments of the present invention will now be described, by way of example only, with reference to the accompanying drawings, in which:—

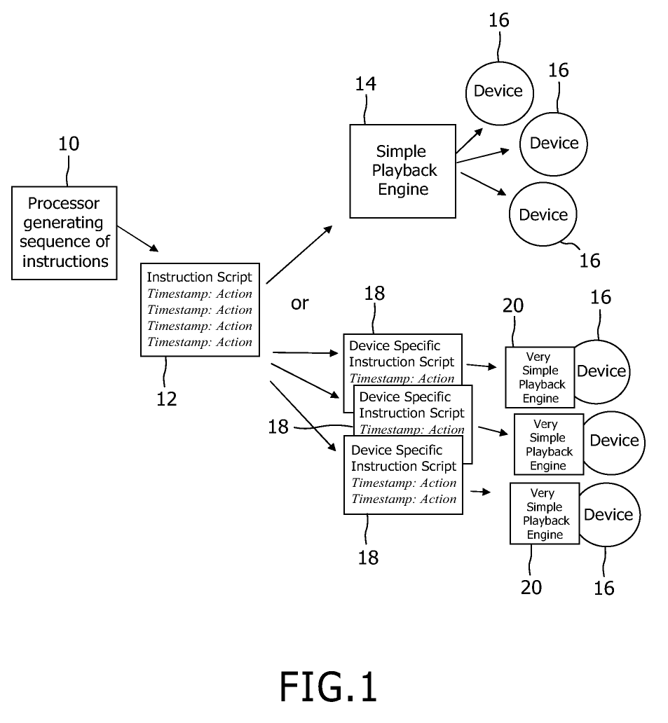

FIG. 1 is a schematic diagram of a system illustrating the generation and delivery of a sequence of instructions,

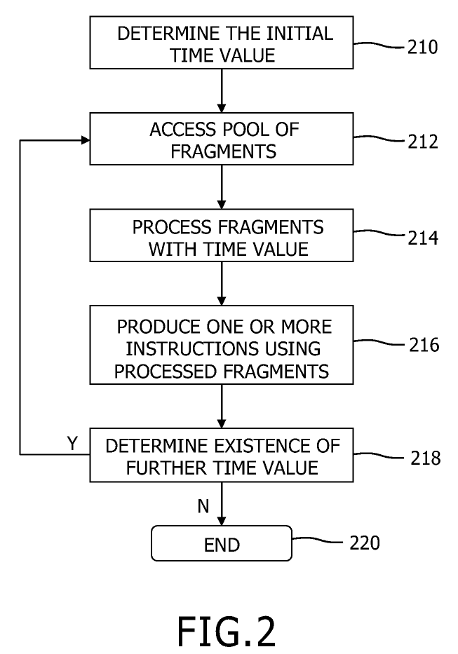

FIG. 2 is a flow diagram of a method of generating a sequence of instructions,

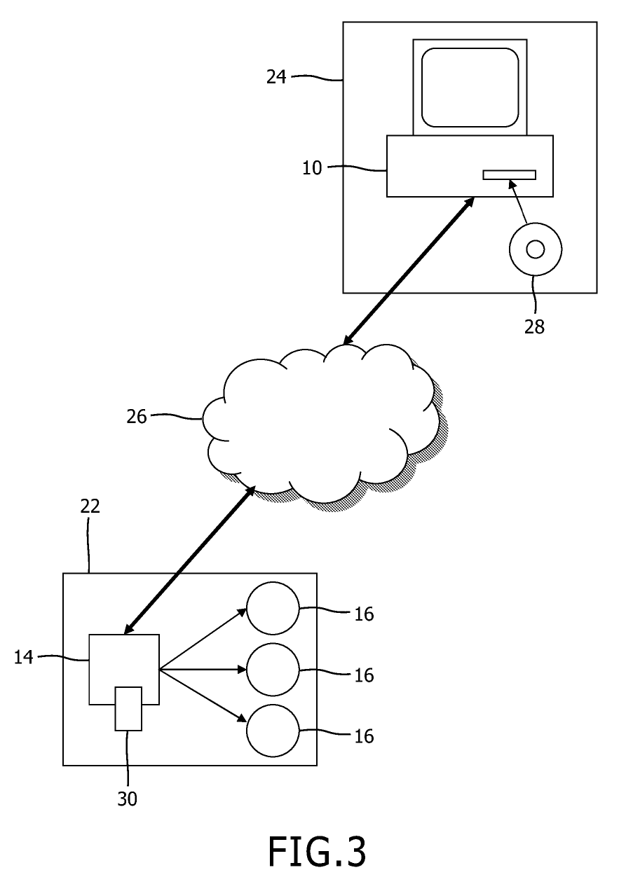

FIG. 3 is a schematic diagram of a system for generating a sequence of instructions,

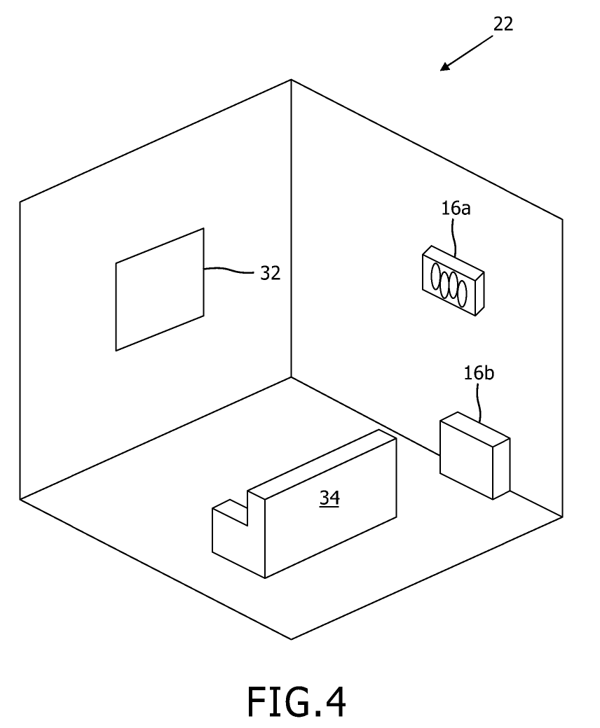

FIG. 4 is a schematic diagram of an environment for delivering an entertainment experience, and

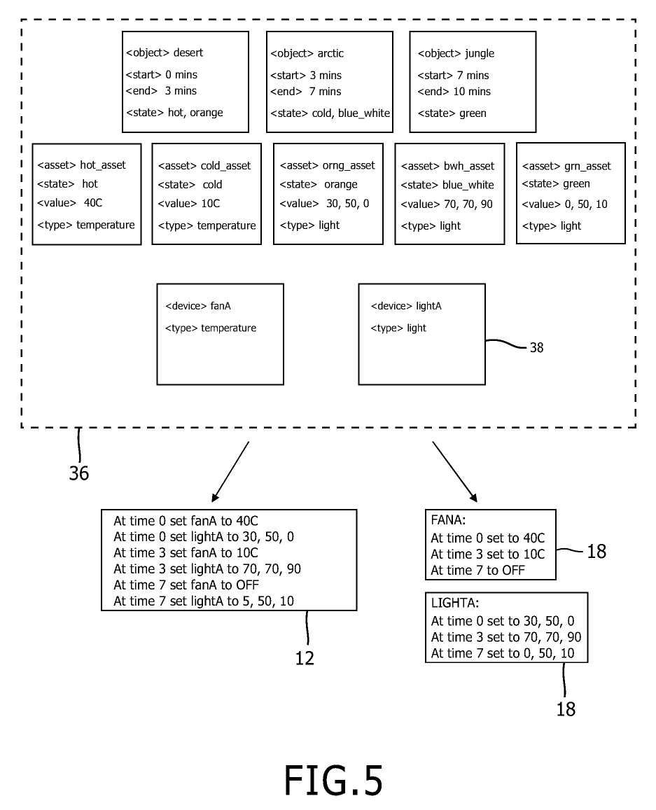

FIG. 5 is a schematic diagram of a pool of markup language fragments and sequences of instructions generated from the pool of markup language fragments.

FIG. 1 shows a system that will use the sequence of time-stamped instructions that are generated by a processor 10. The output of the processor 10 is a sequence of time-stamped instructions, the generation of which will be discussed in detail with reference to the flowchart of FIG. 2.

In the simplest embodiment of an augmentation system, an engine 14 receives the sequence of instructions and uses these to control the devices 16, which are to be used to provide an ambient environment augmenting the entertainment experience of the user. The instructions are processed by the engine 14, which maintains a clock for timing, and used to control the individual devices 16 when they are needed.

An alternative possibility for the operation of the augmentation system is for the sequence of instructions 12 to be divided up into a plurality of device-specific files 18, each comprising respective sequences of time-stamped instructions. These individual files 18 are then passed on to very simple engines 20, which are then used to control respective devices 16 that make up the local augmentation system.

The method of generating the sequence of time-stamped instructions 12 is shown in FIG. 2, which is carried out by the functional block 10 in FIG. 1, which is the processor 10. The method of generating the sequence of instructions 12 comprises determining 210 an initial time value, accessing 212 a pool of markup language fragments, processing 214 the markup language fragments according to the time value, and producing 216 one or more sequence of time-stamped instructions 12 from the processed markup language fragments. If further time values are detected, then, at step 218, the processor 10 returns to step 212 and repeats the processing of the fragments with the new time value.

For a simple entertainment experience such as a film, a pool of markup fragments supports the augmentation of the film. These fragments can be acquired in many different ways. For example, if the film is provided on a DVD, then that DVD may carry the fragments. Alternatively, the fragments may be recalled from local storage by a PC or entertainment centre, or assembled from one or more remote sources such as Internet services. The processor 10 of the system translates those fragments into a usable set of time-stamped instructions that can be utilised by a simple augmentation system that has devices that cannot process markup language fragments.

In step 210 of FIG. 2, an initial time value is first determined by the processor 10, which is carrying out the generation of the sequence of time-stamped instructions 12. This initial time value may be time 0, or some other time can be used as the start time. One method of determining the initial time value is to access the pool of markup language fragments and determine the next earliest time value that is contained within one or more markup language fragments.

Once the initial time value has been determined, the processor 10 accesses 212 the pool of markup language fragments, and processes 214 the fragments to produce one or more time-stamped instructions 12, which relate to the initial time that is being used to process the fragments. Once this processing has been completed, at step 216, then the processor 10, at step 218 determines if there exists a further time value for which instructions should be generated. If there is no further time value, then the method terminates at step 220.

If, however a further (later) time value is determined, then the method moves back to step 212 and once again processes the fragments within the pool for the new time. This process is then repeated until all possible time values have been used to process the pool of fragments. The final set of instructions may be as a single file comprising the sequence of time-stamped instructions 12 or be a plurality of device-specific files 18, each comprising respective sequences of time-stamped instructions 12. FIGS. 4 and 5 illustrate in more detail the steps of generating the time-stamped instructions, with reference to a specific example of a pool of markup language fragments.

The method can further comprise monitoring the pool of markup fragments, and following detection of a change in the pool of markup fragments, re-producing the sequence of time-stamped instructions.

The processing of the fragments to generate a sequence of instructions 12 may be executed at a location that is remote from the specific augmentation environment where the user is actually experiencing the entertainment product such as a film. This is shown in FIG. 3, which shows a location 22 where the augmentation is taking place, which includes the simple playback engine 14 and the devices 16 that provide the ambient environment. This location 22 is remote from a second location 24, where the processor 10 is carrying out the generation of the sequence of instructions 12. A network 26, such as the Internet, connects the two locations 22 and 24.

The processor 10 executes a series of commands from a CD-ROM 28 to carry out the method of generating the sequence of instructions 12. In a preferred embodiment, the processor 10 accesses an end-system description 30, which describes the devices 16, and during the step of producing the sequence of time-stamped instructions 12 uses the end-system description 30 to determine the time-stamped instructions 12.

The step of accessing the end-system description 30 is carried out across the network 26, and the processor 10 transmits the sequence of time-stamped instructions 12 back across the network 26 to the location 22 of the end-system description 30. The processor 10 uses the description 30 to limit the ultimate sequence of instructions 12 to instructions that relate to the devices 16 that are present at the location 22. For example, if the end-system description 30 indicates that there are no rumble pads present at the location 22, then the processor 10 will not include any vibration instructions in the sequence of instructions 12 that is transmitted back to the location 22.

FIG. 4 shows an example of the location 22, with a display device 32 showing a film to a user who is sitting on the couch 34. Two augmentation devices are also present, a light 16a and a fan 16b. The environment shown in FIG. 4 is simplified for purposes of explanation, as many more devices are likely to be present that can contribute to the ambient environment. Provided with the film or compiled from one or more alternate sources such as a local PC is a pool 36 of ten markup language fragments 38, shown in FIG. 5. Again the number and complexity of the fragments 38 has been reduced for simplicity of explanation.

The film that the user is watching contains three scenes, one in a desert, the next in the Arctic and third in a jungle. A simple description of the scenes is created in a markup language. The fragments 38 in the pool 36 are of three types, and the top three fragments 38 in the pool 36 describe objects that correspond to the three scenes in the film, defining the time that the objects persist and, in general terms, the augmentation that is provided. It will be appreciated that a great variety of objects and augmentation is possible with a system operating in this manner.

The second type of fragments are assets that match the augmentation listed in the objects and the third type describes the devices that are present in the location 22.

These fragments 38 make up the markup language description that has been delivered to the processor 10 at the start of the film. It is now assumed that the system has become closed, that time will pass and no new material will be added or removed. A flattened representation of the fragments 38 will be generated by the processor 10 as a time annotated list of actions, either for the simple playback engine 14 or for a very simple playback engine 20 in each device 16.

The approach described above is implemented by essentially running the system forward in time from real time as rapidly as possible. This can be achieved particularly efficiently as it is always known when the next events will occur in a closed system. At each known event in future time, a ‘snapshot’ can take place and the relevant instructions be generated and time stamped. Typically this would be stored in a file.

At each snapshot the next timestamp is indicated and so the process can be repeated. This would continue as far forward in time as it was known that the system would remain ‘closed’ or as was practical given the resources available to the system and possible devices. The completed file is then played back by the simple playback engine 14, or the appropriate elements sent direct to rendering devices where a similar (but device dedicated) playback engine would carry out the sequence of instructions.

In the fragments 38 of FIG. 5, the processor will ascertain from the three object fragments 38 (desert, arctic and jungle) the initial time values 0, and this makes up the initial time value determined in the first method step 210 of FIG. 2. The processor 10 will then access the fragments 38 in the pool 36 and process the fragments 38 with the time value.

The first time value is 0, and from the fragment “desert”, the processor 10 will determine that the states “hot” and “orange” are live at time 0. The processor 10 then searches for fragments 38 that give values for these states and the type of device to which the values relate. In the case of “hot” there is a value of 40C for a temperature device from the fragment “hot_asset”. There is also a fragment 38 defining the fanA (device 16b in FIG. 4) and this therefore translates into an instruction “At time 0 set fanA to 40C”. This process is then repeated for each of the fragments 38 that provide the states “hot” and “orange”.

Once this is completed, the processor 10 moves forward to the next time value, which is 3. A new sequence of instructions is generated for this time value, which may include reversal of the instructions given at time 0. This process is repeated for each time value that is detected by the processor 10. In this way, the sequence of time-stamped instructions 12 is generated, either as a single file or as a series of device specific files 18.

It will be appreciated that the system is described as determining a single time value t, which is then used to calculate instructions at that time t, and then a next time t+1 is looked for, but alternative methods of producing the sequence of time-stamped instructions are possible. For example, all of the time values could be determined at the start and then the fragments processed for each and every time value at once. However, the preferred embodiment is to take each time value in turn and then process the fragments into instructions and seek the next time value.

If at any point the system became ‘open’ again the simple playback engine could be interrupted with a new description or the processor 10 (operating as a full system engine) could take over control. The sequence of instructions could be coded, encrypted or compressed at any point if that was advantageous for security, efficiency, or speed. As the processor 10 would not be required to carry out the sending of instructions when creating the flattened instructions, and also would not have to wait during periods of no or low activity for the next ‘snapshot’, a significant amount of content could be very quickly processed in most situations.

A further possible advantageous use could be to de-couple the processor 10 from the playback by letting it run ahead. In essence, this involves filling the bottom of the instruction sequence as fast as possible with the simple playback engine 14 managing the timely issuing of instructions to devices. With this approach any highly intensive processing required for complex sections of the material may be met ahead of time, providing some ‘breathing space’. During the production of the sequence of time-stamped instructions, any generated instructions are transmitted onwards.

From reading the present disclosure, other variations and modifications will be apparent to the skilled person. Such variations and modifications may involve equivalent and other features which are already known in the art, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1. A method for generating a sequence of instructions (12) comprising determining one or more time values, accessing a pool (36) of markup language fragments (38), processing the markup language fragments (38) according to the or each time value, and producing a sequence of time-stamped instructions (12) from the processed markup language fragments (38).

2. A method according to claim 1, wherein the step of determining the or each time value comprises accessing the pool (36) of markup language fragments (38) and determining the or each time value within one or more markup language fragments (38).

3. A method according to claim 1, wherein the step of producing the sequence of time-stamped instructions (12) comprises generating a single file comprising the sequence of time-stamped instructions (12).

4. A method according to claim 1, wherein the step of producing the sequence of time-stamped instructions (12) comprises generating a plurality of device-specific files (18), each comprising respective sequences of time-stamped instructions (12).

5. A method according to claim 1, and further comprising accessing an end-system description (30) and during the step of producing the sequence of time-stamped instructions (12) using the end-system description (30) to determine the time-stamped instructions (12).

6. A method according to claim 5, wherein the step of accessing the end-system description (30) is carried out across a network (26), and the method further comprises transmitting the sequence of time-stamped instructions (12) back across the network (26) to the location of the end-system description (30).

7. A method according to claim 1, and further comprising monitoring the pool (36) of markup fragments (38), and following detection of a change in the pool (36) of markup fragments (38), re-producing the sequence of time-stamped instructions (12).

8. A method according to claim 1, and further comprising, during the production of the sequence of time-stamped instructions (12), transmitting any generated instructions (12) to one or more devices (16).

9. A computer program product on a computer readable medium comprising a set of commands for generating a sequence of instructions (12), the set comprising commands for: determining one or more time values, accessing a pool (36) of markup language fragments (38), processing the markup language fragments (38) according to the or each time value, and producing a sequence of time-stamped instructions (12) from the processed markup language fragments (38).

10. A computer program product according to claim 9, wherein the command for determining the or each time value comprises commands for accessing the pool (36) of markup language fragments (38) and determining the or each time value within one or more markup language fragments (38).

11. A computer program product according to claim 9, wherein the command for producing the sequence of time-stamped instructions (12) comprises a command for generating a single file comprising the sequence of time-stamped instructions (12).

12. A computer program product according to claim 9, wherein the command for producing the sequence of time-stamped instructions (12) comprises a command for generating a plurality of device-specific files (18), each comprising respective sequences of time-stamped instructions (12).

13. A computer program product according to claim 9, and further comprising a command for accessing an end-system description (30), the command for producing the sequence of time-stamped instructions (12) using the end-system description (30) to determine the time-stamped instructions (12).

14. A computer program product according to claim 13, wherein the command for accessing the end-system description (30) is carried out across a network (26), and the product further comprises a command for transmitting the sequence of time-stamped instructions (12) back across the network (26) to the location of the end-system description (30).

15. A computer program product according to claim 9, and further comprising commands for monitoring the pool (36) of markup fragments (38), and following detection of a change in the pool (36) of markup fragments (38), re-producing the sequence of time-stamped instructions (12).

16. A computer program product according to claim 9, and further comprising a command for transmitting any generated instructions (12) to one or more devices, during the production of the sequence of time-stamped instructions (12).

17. A system for generating a sequence of instructions (12) comprising a processor (10) arranged to determine one or more time values, to access a pool (36) of markup language fragments (38), to process the markup language fragments (38) according to the or each time value, and to produce a sequence of time-stamped instructions (12) from the processed markup language fragments (38).

18. A system according to claim 17, wherein the processor (10) is arranged, when determining the or each time value, to access the pool (36) of markup language fragments (38) and to determine the or each time value within one or more markup language fragments (38).

19. A system according to claim 17, wherein the processor (10) is arranged, when producing the sequence of time-stamped instructions (12), to generate a single file comprising the sequence of time-stamped instructions (12).

20. A system according to claim 17, wherein the processor (10) is arranged, when producing the sequence of time-stamped instructions (12), to generate a plurality of device-specific files (18), each comprising respective sequences of time-stamped instructions (12).

21. A system according to claim 17, and further comprising a storage device storing an end-system description (30), the processor (10) arranged, when producing the sequence of time-stamped instructions (12), to use the end-system description (30) to determine the time-stamped instructions (12).

22. A system according to claim 17, wherein the processor (10) is further arranged to monitor the pool (36) of markup fragments (38), and following detection of a change in the pool (36) of markup fragments (38), to re-producing the sequence of time-stamped instructions (12).

23. A system according to any claim 17, wherein the processor (10) is further arranged, during the production of the sequence of time-stamped instructions (12), to transmit any generated instructions (12) to one or more devices (16).
